(19) United States
(12) Patent Application Publication
(10) Pub. No.: US 2026/0319503 A1
(43) Pub. Date: Oct. 15, 2026

(54) NAVIGATION METHOD FOR ROBOT TO PASS THROUGH NARROW PASSAGE, CHIP, AND ROBOT

(71) Applicant: AMICRO SEMICONDUCTOR CO.,LTD., Zhuhai, Guangdong (CN)

(72) Inventors: Songzhou XU, Zhuhai, Guangdong (CN); Zhaorui OU, Zhuhai, Guangdong (CN); Hewen ZHOU, Zhuhai, Guangdong (CN); Huibao HUANG, Zhuhai, Guangdong (CN); Ming SUN, Zhuhai, Guangdong (CN); Zhuobiao CHEN, Zhuhai, Guangdong (CN)

(73) Assignee: AMICRO SEMICONDUCTOR CO.,LTD., Zhuhai, Guangdong (CN)

(21) Appl. No.: 19/104,227

(22) PCT Filed: Jul. 14, 2023
(86) PCT No.: PCT/CN2023/107352

§ 371 Date: Feb. 16, 2025

(30) Foreign Application Priority Data
Aug. 16, 2022 (CN) 202210982509.5

(51) Int. Cl. G05D 1/622; A47L 11/40; G05D 1/644; G05D 105/10; G05D 109/10; G05D 111/10

(52) U.S. Cl. CPC G05D 1/622; A47L 11/4011; A47L 11/4061; G05D 1/644; A47L 2201/04; G05D 2105/10; G05D 2109/10; G05D 2111/17

(57) ABSTRACT

A navigation method for a robot to pass through a narrow passage, a chip, and a robot. The navigation method includes: in S1, the robot fitting a positioning contour line segment as a currently fitted positioning contour line segment for an obstacle when the robot collides with it after entering the narrow passage, the then rotating until its current walking direction aligns with a preset travel direction of the currently fitted positioning contour line segment or is deflected by a preset angle towards a passable area relative to the currently fitted positioning contour line segment, avoiding being currently blocked by the obstacle from moving forward; and in S2, the robot walking straight in the current walking direction until colliding with the obstacle and then proceeding to execute SI. The robot stops executing S1 when reaching a preset target position and determines that the robot has passed through the narrow passage.

### TECHNICAL FIELD

The present application relates to the technical field of mobile robot navigation, and in particular to a navigation method for a robot to pass through a narrow passage, a chip, and a robot.

### BACKGROUND

During cleaning, a cleaning robot may encounter a narrow passage formed between two walls or low obstacles and only slightly wider than the robot's body. In such cases, the robot will actively avoid the obstacles upon contact and bypass the obstacles and the narrow passage by making a wide turn, though such narrow passage often provides a more direct route to a target position. Typically, the narrow passage is flanked by (the contour lines of) the obstacles. When configuring a movement path, the cleaning robot is generally treated as a point. To facilitate the robot to reach a target position in another room, the configured movement path may need to pass through such a narrow passage. However, due to calculation errors and the need for efficient exploration, a navigation path planned for the robot may not be well-suited for narrow passage environments. As a result, navigation in these confined spaces may not be smooth enough or consistently repeatable.

### SUMMARY

In order to solve at least one of the above technical problems, the present disclosure provides a navigation method for a robot to pass through a narrow passage, a chip, and a robot. The specific technical solutions are as follows.

A navigation method for a robot to pass through a narrow passage, including: operation S1 of the robot fitting a positioning contour line segment, as a currently fitted positioning contour line segment, for an obstacle when the robot collides with the obstacle after entering the narrow passage,, the robot then rotating until a current walking direction of the robot is consistent with a preset travel direction of the currently fitted positioning contour line segment or the currently waling direction of the robot is deflected by a preset angle towards a passable area of the narrow passage relative to the currently fitted positioning contour line segment, so that the robot is not currently blocked by the obstacle from moving forward; and operation S2 of the robot walking straight in the current walking direction until it collides with the obstacle and then the robot proceeding to execute the operation S1. the operation S2 is executed by the robot after the operation S1; and the robot stops executing the operation S1 when the robot reaches a preset target position, and determines that the robot has passed through the narrow passage.

Further, in the operation S1, for each positioning contour line segment fitted by the robot, the robot sets an endpoint of the positioning contour line segment that forms a shortest passable path relative to the preset target position as a target endpoint of the positioning contour line segment. The shortest passable path is located within the passable area of the narrow passage entered by the robot, the robot configures a direction of an end point of the positioning contour line segment other than the target endpoint pointing to the target endpoint as the preset travel direction of the positioning contour line segment.

Further, the robot configures a channel where the target endpoint of each positioning contour line segment is located as the narrow passage, the robot sets the positioning contour line segment as a boundary line of the narrow passage. Each time the robot collides with a new obstacle, the robot fits a positioning contour line segment for the new obstacle, obtains the target endpoint of the positioning contour line segment of the new obstacle, and identifies an opening of the channel where the target endpoint is located as an opening of the narrow passage.

Further, in the operation S2, before the robot reaches the preset target position, if the robot identifies an opening of the narrow passage, the robot determines the opening of the narrow passage as an exit of the narrow passage, and then adjusts the current walking direction to align with the preset travel direction of the currently fitted positioning contour line segment or deflect the current walking direction by the preset angle towards the passable area relative to the currently fitted positioning contour line segment. Then, the robot walks straight in the current walking direction to exit the narrow passage.

Further, the navigation method further includes that: before the robot enters the narrow passage, if the robot identifies an opening of the narrow passage, the robot identifies the opening of the narrow passage as an entrance of the narrow passage, and then adjusts the current walking direction to align with the preset travel direction of the currently fitted positioning contour line segment or deflect the current walking direction by the preset angle to the passable area relative to the currently fitted positioning contour line segment; and then the robot walks straight in the current walking direction to enter the entrance of the narrow passage, and proceeds to execute the operation S1.

Further, before the robot starts to identify the opening of the narrow passage, if the robot collides with the obstacle, the robot marks the obstacle as a most recently detected obstacle before starting to identify the opening of the narrow passage, fits the positioning contour line segment for the obstacle, then adjusts the current walking direction to align with the preset travel direction of the currently fitted positioning contour line segment, so that the robot walks along the currently fitted positioning contour line segment, until colliding with a new obstacle, and then the robots fits a corresponding positioning contour line segment for the new obstacle, and then starts to identify the opening of the narrow passage.

Further, each time the robot rotates until the current walking direction aligns with the preset travel direction of the currently fitted positioning contour line segment or is deflected by the preset angle towards the passable area relative to the currently fitted positioning contour line segment, the robot walks straight in the current walking direction for a preset safety distance, and during the straight walking, detects whether the robot collides with the obstacle; if the robot collides with the obstacle, the robot proceeds to execute the operation S1; otherwise, it is determined that the robot has passed through the narrow passage, then uses a heuristic search algorithm to plan a path towards the preset target position or to a position closest to another detected obstacle in the current walking direction, and walks along the planned path until the robot identifies and enters an entrance of another narrow passage, and then proceeds to execute the operation S1.

Further, the robot identifying of the opening of the narrow passage includes that: the robot first fits a positioning contour line segment for a most recently collided obstacle, then extracts two obstacle avoidance points in a search direction of the positioning contour line segment; and if a distance between the two obstacle avoidance points is within a preset distance range, the robot identifies a channel where the two obstacle avoidance points are located as the narrow passage and identifies a gap formed between obstacles where the two obstacle avoidance points are respectively located as the opening of the narrow passage.

Further, after the robot identifies the opening of the narrow passage, if the robot detects that a walking direction of the robot changes from a reference obstacle avoidance direction to the preset travel direction of the currently fitted positioning contour line segment or is deflected by the preset angle towards the passable area relative to the currently fitted positioning contour line segment, and the robot walks straight in the changed walking direction, the robot identifies that it has entered the narrow passage. The changed walking direction is configured to point from a current position of the robot to a passable area inside the channel where the two obstacle avoidance points are located, the reference obstacle avoidance direction is a preset travel direction of a previously fitted positioning contour line segment or is deflected by the preset angle towards a passable area relative to a previously fitted positioning contour line segment, and the previously fitted positioning contour line segment is a positioning contour line segment fitted for the most recently collided obstacle before the robot starts to identify the opening of the narrow passage.

Further, before starting to identify the narrow passage entrance, the robot collides with one obstacle and fits a corresponding positioning contour line segment for the obstacle; when the robot subsequently collides with another obstacle, it starts to identify the opening of the narrow passage. The positioning contour line segment fitted by the robot for the previously collided obstacle is the previously fitted positioning contour line segment, while a positioning contour line segment fitted by the robot for the subsequent collided obstacle is the currently fitted positioning contour line, wherein the preset travel direction of the previously fitted positioning contour line segment is made different from the preset travel direction of the currently fitted positioning contour line segment

Further, the robot sets the search direction of the positioning contour line segment as a direction perpendicular to the positioning contour line segment, to form a width direction of the channel where the two obstacle avoidance points are located. The two obstacle avoidance points are distributed along the search directions of the positioning contour line segment, and respectively in the obstacle that the robot most recently collides with before the robot starts to identify the opening of the narrow passage, and in another obstacle that the robot collides with when the robot starts to identify the opening of the narrow passage

Further, the preset distance range is set to be greater than or equal to a width of the robot's body; the preset safety distance is set to be equal to the width of the robot's body. The preset angle is set to guide the robot to leave a currently collided obstacle, or bypass any endpoint of the positioning contour line segment of the currently collided obstacle, so as to walk to the passable area connected to the present target position. The shortest passable path is a shortest one among paths leading to the preset target position which are planned by the robot through respectively taking the two endpoints of the positioning contour line segment as a search starting point and using the heuristic search algorithm

A chip storing program code, wherein when the program code is executed, the chip implements the operations of the navigation method.

A robot equipped with a distance sensor, wherein the robot is provided with the chip, and is configured to control the robot to use the distance sensor to detect point cloud data of an obstacle and fit corresponding positioning contour line segments from the point cloud data, so as to execute the operations of the navigation method to enable the robot to pass through the narrow passage.

The beneficial effects of the present disclosure are as follow. In the narrow passage, the robot disclosed in the present disclosure tentatively moves forward along a specific direction indicated by the fitted positioning contour line segment (a direction of a shortest path towards the preset target position in the narrow passage), and identifies the opening of the narrow passage through collision with the obstacle and adjusts its direction in time to avoid obstacles. This process is repeated so that the robot walks along the path from the starting position to the preset target position, so as to realize alternate turning directions and advancement towards the preset target position through the narrow passage. In this way, the robot is controlled to accurately avoid obstacles in the narrow passage, so as to smoothly pass through narrow passages and other complex narrow channels whose widths are 1 cm larger than the width of the robot's body, improving smoothness and a success rate of the robot passing through narrow passages.

The robot identifies the channel where the two obstacle avoidance points are located as a narrow passage and determines that it has entered the narrow passage as long as its walking direction changes from the reference obstacle avoidance direction to the preset travel direction of the currently fitted positioning contour line segment or is deflected by the present angle towards the passable area relative to the currently fitted positioning contour line segment, the robot walks straight in the changed walking direction, and the distance between the two obstacle avoidance points falls within the preset distance range.

In the present disclosure, the robot adjusts the walking direction of the robot based on the collision between the robot and the obstacle and the fitting of the contour of the obstacle at various stages: before the robot identifies the opening of the narrow passage, when the robot starts to identify the opening of the narrow passage, after the robot identifies the opening of the narrow passage, before the robot enters the narrow passage, and after the robot enters the narrow passage. The robot then walks straight in the narrow passage to approach the preset target position. Additionally, the robot identifies the opening of the narrow passage based on sequential collisions with two obstacles and the fitting of the contour of each obstacle. This process distinguishes three identification states: before the robot identifies the opening of the narrow passage, when the robot starts to identify the opening of the narrow passage, and after the robot identifies the opening of the narrow passage. This approach facilitates the robot's advancement into a narrow passage and subsequently into the narrow passage again.

### BRIEF DESCRIPTION OF THE DRAWINGS

FIG. 1 is a flow chart of a navigation method for a robot to pass through a narrow passage disclosed in an embodiment of the present disclosure.

FIG. 2 is a schematic diagram of a movement trajectory of a robot passing through a narrow passage according to another embodiment of the present disclosure.

### DETAILED DESCRIPTION

The technical solutions in embodiments of the present disclosure will be described in detail below with reference to the accompanying drawings in some embodiments of the present disclosure. To further explain the various embodiments, the present disclosure provides drawings. These drawings are part of the content of the present disclosure, mainly used to illustrate the embodiments, and can be used to explain the operating principles of the embodiments in conjunction with the relevant descriptions in the specification. With reference to these contents, those of ordinary skill in the art will be able to understand other possible implementations and advantages of the present disclosure. A process or method is depicted as a flowchart. Although the flowchart depicts operations as a sequential process, many of the operations may be performed in parallel, concurrently, or simultaneously. Additionally, an order of the operations may be rearranged. The process may be terminated when the operations have been completed, but may further include additional operations not included in the figures. The process may correspond to a method, function, procedure, subroutine, subroutine, or the like.

When the robot passes through a narrow passage, in order to overcome an excessive calculation errors produced in a process of fitting contour line segments and a sensor error introduced by a planned walking direction, so that the robot can be navigated to smoothly travel in and through the narrow passage, the present disclosure provides a navigation method for a robot to pass through a narrow passage. An execution subject of the navigation method is a robot equipped with a ranging sensor. In the present disclosure, the navigation method is automatically executed by the robot, which can not only accept human input instructions, but also run pre-arranged program instructions, and can further autonomously formulate and execute tasks based on artificial intelligence technology. The robot may be a cylinder, which integrates at least a collision sensor and a ranging sensor. The ranging sensor can be a line laser sensor, which emits a line laser to the outside to obtain position information reflected by an obstacle. By detecting two-dimensional point cloud data of the surrounding environment, a two-dimensional point cloud map can be constructed in time. The number of the line laser sensor(s) installed on the robot's body can be one or more. The line laser sensors include a multi-line laser radar and a single-line laser radar. The single-line laser radar refers to a radar whose laser source emits a single line beam. The single-line laser radar is used in the field of robots, mostly service robots, which can help robots to avoid obstacles. The single-line laser radar offers a fast scanning speed, a good resolution, and high reliability. Compared to the multi-line laser radar, the single-line laser radar responds more quickly in terms of angular frequency and sensitivity, making it more accurate in measuring distances to surrounding obstacles. Particularly, the robot may include cleaning robots that walk on ground surface, lawn mower robots that walk on lawn areas with narrow passages demarcated by boundary lines, floor washing machines, and security patrol robots. However, this embodiment does not limit a type of the subject to which the navigation method is applicable. The robot can also be equipped with inertial sensors (including but not limited to odometers for measuring walking distances, collision sensors for detecting collisions with obstacles, and gyroscopes for measuring body rotation angles), or visual sensors (which can utilize any type of depth information collection device, including but not limited to monocular cameras, binocular cameras, and the like).

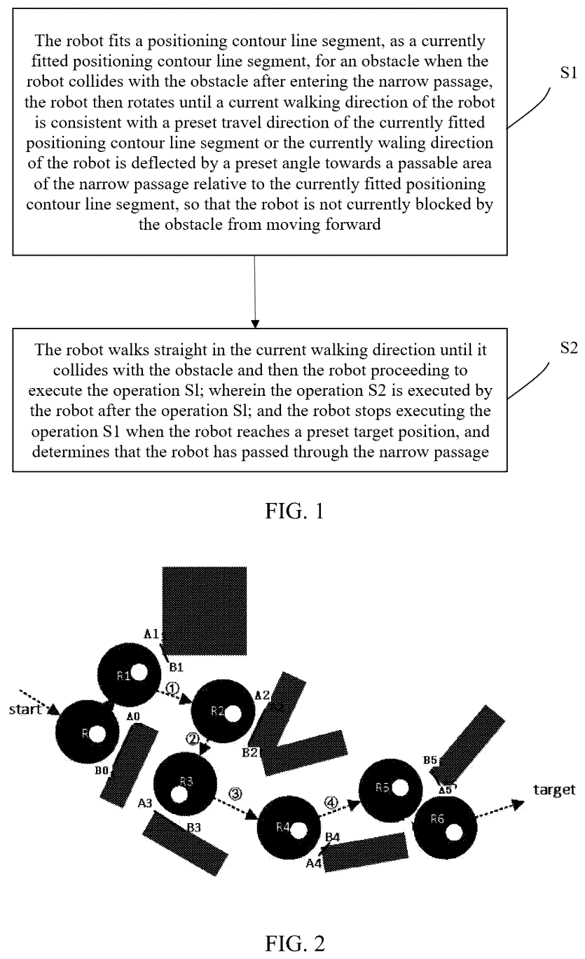

Referring to FIG. 1, it can be seen that the navigation method includes an operation S1: after a robot enters a narrow passage, if colliding with an obstacle, the robot fits a positioning contour line segment of the obstacle as a currently fitted positioning contour line segment by the robot, wherein the currently fitted positioning contour line segment represents a contour line segment of the obstacle most recently detected by the robot; then, the robot rotates, specifically rotates in place, until a current walking direction of the robot is consistent with a preset travel direction of (according to) the currently fitted positioning contour line segment, or until the current walking direction of the robot is deflected by a preset angle towards a passable area relative to the currently fitted positioning contour line segment, so that the robot is not blocked by the obstacle currently. When the current walking direction of the robot is consistent with the preset travel direction of the currently fitted positioning contour line segment, the current walking direction of the robot is parallel to the currently fitted positioning contour line segment, and in the narrow passage, the current walking direction of the robot aligns with an extension direction of a shortest path pointing towards a preset target position. In addition, the implementation of deflecting the robot by the preset angle towards the passable area includes: when there is a passable area (not occupied by any obstacle) on the left side of the currently fitted positioning contour line segment or on the left side of the obstacle where the currently fitted positioning contour line segment is located, the robot is deflected to the left relative to an extension direction of the currently fitted positioning contour line segment; when there is a passable area (not occupied by any obstacle) on the right side of the currently fitted positioning contour line segment or on the right side of the obstacle where the currently fitted positioning contour line segment is located, the robot is deflected to the right relative to the extension direction of the currently fitted positioning contour line segment; and the preset angle is related to the accuracy of fitting calculation, wherein the higher the accuracy, the closer the currently fitted positioning contour line segment is to the obstacle, and vice versa. The preset angle is preferably in a range of 0 to 30 degrees. The robot then executes an operation S2.

It should be noted that the method for the robot to fit the positioning contour line segment includes that: for narrow passages, the point cloud data (radar points) collected by the line laser sensor disclosed in this embodiment are all represented by discrete coordinates, and these discrete coordinates specifically indicates locations of obstacles. Most of these discrete coordinates need to be screened and grouped. The grouped point cloud data are then fitted to obtain a fitted straight line or a fitted curve. Then, based on a proportional conversion relationship between a world coordinate and an image coordinate, an envelope (envelop curve) of the obstacle may be derived from coordinate points of the fitted curve or fitted straight line. Preferably, to ensure the efficiency of a path planning algorithm, a simple robot particle model is used during a path search stage. Preferably, virtual expansion is performed on the fitted curve or fitted straight line, with an expansion radius set to a radius of an inscribed circle or a radius of a circumcircle of a contour projection of the robot. This process forms a fitted circle surrounding the obstacle, correspondingly creating the envelope of the obstacle. This envelope is displayed in real-time on a grid map, with the point cloud data discretely distributed around the obstacle in a surrounding manner, not only corresponding to a laser detection distance from the obstacle to the robot but also effectively indicating the location of obstacle.

In the operation S2, the robot walks in a straight line in the current walking direction until it collides with an obstacle, and then executes the operation S1. During the process of repeating the operation S1 and the aforementioned walking in the straight line, if the robot walks to the preset target position, it stops executing the operation S1, and it is determined that the robot has passed through the narrow passage. Preferably, the preset target position is located outside the narrow passage and is connected to the passable area inside the narrow passage to allow the robot inside the narrow passage to walk straight to the preset target position.

Specifically, for the operation S2, once the robot rotates until the current walking direction of the robot is consistent with the preset travel direction of the currently fitted positioning contour line segment or until the currently walking direction of the robot is deflected by the preset angle towards the passable area relative to the currently fitted positioning contour line segment, the robot walks in a straight line following the current walking direction for a preset safe distance, and detects whether the robot collides with an obstacle during walking in the straight line. If so, the operation S1 is executed to achieve accurate obstacle avoidance for the robot ; otherwise, it is determined that the robot has passed through the narrow passage and has currently exited the narrow passage. Preferably, the preset safety distance is configured as a width of the robot's body to meet width requirements within a narrow passage environment. Then, a heuristic search algorithm is used to plan a path towards the preset target position, or a path towards a detected obstacle closest to the robot in the current walking direction (which may be an obstacle closet to a current position of the robot), which can be a path towards a local target position closest to a contour of the corresponding obstacle. Then, the robot walks along the planned path, if the robot is in an area close to the preset target position, it will walk along the path towards the preset target position, or if the robot is far away from the preset target position and is in a local area where it is surrounded by obstacles on three sides, it will walk along the path towards the local target position, until the robot identifies an entrance of another narrow passage and enters the narrow passage. Then, the operation S1 is executed for the robot to enter the new narrow passage along a new direction.

Preferably, a prerequisite for the robot to identify the entrance of another narrow passage includes: while walking along the planned path, the robot has detected or collided with a new obstacle and started to identify an opening of the narrow passage (i.e., the narrow passage opening). In FIG. 2, the robot navigates from a position start to a position target (i.e., the preset target position), encounters an obstacle at a position R, uses point cloud data to fit a line segment A0B0, and then determines whether the current walking direction is A0 pointing to B0 or B0 pointing to A0 based on a local target position R1 or the preset target position “target”. Then, the robot chooses the direction B0 pointing to A0 as the current walking direction and moves to the local target position R1, during which the robot may collide with an obstacle on its right side and start to identify an opening of a narrow passage. When the robot identifies at position R1 that a gap between a position B1 and the position A0 is the opening of the narrow passage, it enters and passes through the opening of the narrow passage and moves until reaching the preset target position “target”. When the robot walks to a position R5, it selects a direction B5 pointing to A5 as the current walking direction, and then walks along this current walking direction to a position R6, which realizes that the robot rotates to a direction without obstacles and does not collide with an obstacle where a positioning contour line segment B5A5 is located or an obstacle where a positioning contour line segment B4A4 is located, and the robot is just able to pass through a corresponding narrow passage opening (that is, an exit of the narrow passage). Then, the heuristic search algorithm is used to plan a path towards the preset target position, and then the robot walks straight along the planned path or a navigation direction towards the preset target position target.

Preferably, the point cloud data describing the environment of the ranging sensor has a limited sensing range and field of view, and cannot describe environmental information around the robot in detail. Then, based on a global path of a navigation task, a local target location of a local plan is selected within a local map range, specifically, looking for a track point closest to an edge of a local map by tracking along the global path from a current position of the robot, and determining the track point as the local target position. The global path is a path to the preset target position planned using the heuristic search algorithm as disclosed in the aforementioned embodiments.

To sum up, in the narrow passage, the robot disclosed in the present disclosure tentatively moves forward along a specific direction (a direction of a shortest path towards the preset target position from inside the narrow passage) indicated by the fitted positioning contour line segment, and identifies the opening of the narrow passage through collision with the obstacle and adjusts its direction in time to avoid obstacles. This process is repeated so that the robot walks along the path from the starting position to the preset target position, so as to realize alternate turning directions and advancement towards the preset target position through the narrow passage. In this way, the robot is controlled to accurately avoid obstacles in the narrow passage, so as to smoothly pass through openings of narrow passages and other complex narrow channels whose widths are 1 cm larger than the width of the robot's body, improving smoothness and a success rate of the robot passing through narrow passages.

In the above embodiment, in the operation S1, for each positioning contour line segment fitted by the robot, the robot sets a target endpoint, which is an endpoint of a shortest passable path formed relative to the preset target position. As the robot passes through the narrow passage over time, positions of the target endpoint in FIG. 2 are a position A0, a position B1, a position B2, a position B3, a position B4, and a position A5 in sequence, which respectively correspond to an endpoint of the positioning contour line segment A0B0, an endpoint of the positioning contour line segment A1B1, an endpoint of a positioning contour line segment A2B2, an endpoint of a positioning contour line segment A3B3, an endpoint of a positioning contour line segment A4B4, and an endpoint of a positioning contour line segment A5B5. The shortest passable path is located within the passable area of the narrow passage entered by the robot. The robot configures a direction from an end point of the positioning contour segment, which is not the target endpoint pointing, to the target endpoint as the preset walking direction of the positioning contour line segment. In FIG. 2, the preset travel directions are sequentially a direction of B0 pointing to A0, a direction indicated by an arrow marked by an index number 1), a direction indicated by an arrow marked by an index number 2), a direction indicated by an arrow marked by an index number 3, a direction indicated by an arrow marked by an index number (4), and a direction of B5 pointing to A5. Therefore, after the robot identifies and enters the opening of the narrow passage, the robot calculates a precise angle by which it needs to rotate in order to avoid obstacles. This adjustment ensures that the robot's walking direction is redirected towards an unobstructed forward direction.

As an embodiment, the robot configures the channel, where the target endpoints of all the positioning contour line segments are located, as narrow passages; and the robot sets the positioning contour line segments as boundary lines of the narrow passages. Whenever the robot collides with a new obstacle, the robot fits a positioning contour line segment for the new obstacle, then obtain the target endpoint of the positioning contour line segment of the new obstacle, which is equivalent to a boundary point of the channel, and identifies an opening of the channel where the target endpoint is located as the narrow passage opening. In this embodiment, before and after executing the operation S1, the robot uses a collision sensor to detect whether there is an obstacle on its walking path during a walking process, and meanwhile uses a ranging sensor to detect whether there is a narrow passage on its walking path. For example, if a width (outer diameter) of the robot's body is D, a passage with a width in a range of (1-α)D to (1+α)D can be determined as a narrow passage, wherein the coefficient a can be designed based on a combination of a shape and material of the robot. For example, a value of α is 0.03.

It should be noted that due to accumulated errors of the robot's sensors, different materials of obstacles, and interference from different lighting environments, an envelope of an obstacle (a peripheral envelope contour of the obstacle, a fitted curve or multiple connected fitted curves) obtained from the point cloud data collected by the laser sensor may not match positions of actual obstacles. Consequently, when searching for a path, the robot may exclude openings of narrow passages from the passable area of the robot, and hence an error of the obstacle envelope is prone to cause the robot to misjudge the narrow passages openings. Therefore, in the present disclosure, the robot uses the robot's collision with obstacles to fit the positioning contour line segments of the obstacles at the appropriate time, and obtains a corresponding guidance direction and takes the opportunity to enter the narrow passages.

As an embodiment, the navigation method further includes: before the robot enters the narrow passage, if the robot identifies the opening of the narrow passage, it identifies the opening of the narrow passage as the entrance to the narrow passage, and then the robot adjusts its current walking direction to align with the preset travel direction of the currently fitted positioning contour line segment or deflect its current walking direction by the preset angle towards the passable area relative to the currently fitted positioning contour line segment. Subsequently, the robot proceeds straight in the current walking direction to bypass the target endpoint of the positioning contour line segment of a most recently detected obstacle before it begins to identify the narrow passage. After that, the robot enters the entrance of the narrow passage and continues with the operation S1.

Based on the above embodiment, before the robot starts identifying a narrow passage opening, if it collides with an obstacle, that obstacle is marked as the most recently detected obstacle by the robot before it starts to identify the narrow passage opening. The robot then fits a positioning contour line segment for this obstacle. Subsequently, the robot adjusts its current walking direction to align with the preset travel direction of the currently fitted positioning contour line segment. This allows the robot to follow the currently fitted positioning contour segment until it collides with a new obstacle. Upon colliding with the new obstacle, the robot fits a corresponding positioning contour line segment for this new obstacle and then starts to identify the narrow passage opening. Specifically, the robot initially collides with an obstacle (the black rectangle closest to the right of the position start in FIG. 2) at position R, which is taken as the most recently detected obstacle before the robot starts to identify the opening of the narrow passage. That is, before the robot starts to identify the narrow passage, a target endpoint of the positioning contour line segment of the most recently detected obstacle is the target endpoint A0 of the positioning contour segment A0B0 in FIG. 2. Then, the robot adjusts its walking direction and starts from the position R to walk to the position R1, following a direction from the position B0 to the position A0. Subsequently, the robot collides with a new obstacle (the black rectangle closest to the upper right of the position R1) at the position R1, and adjusts its walking direction to align with the direction indicated by the arrow marked by index number \textcircled{1} (which can be considered as parallel to the positioning contour line segment A1B1 fitted for the new obstacle). As the robot starts from the position R1 to walk along the direction indicated by the arrow marked by the index number \textcircled{1}, it is identified that the robot enters the narrow passage and bypasses the position A0.

Based on the above embodiment before the robot entering the narrow passage, preferably, for a fixed narrow passage that is not formed temporarily, after the robot is facing directly towards the narrow passage, it may identify one narrow passage opening, and then may be deflect by a first preset angle (such as 30 degrees) to left or right and move in a straight line to enter the narrow passage opening. If the robot collides, it indicates that it has reached a boundary of one side of the narrow passage. The robot may exit the narrow passage via a gap at its current position and identify a new narrow passage opening, and then may be deflect by a second preset angle (such as 60 degrees) in an opposite direction and move in a straight line to enter the new narrow passage opening. If the robot collides again, it indicates that it has reached a boundary on the other side of the narrow passage. This process is repeated. Positions that the robot walks sequentially correspond to R1->R2->R3->R4->R5->R6, so that the robot passes through the corresponding narrow passage. This allows the robot to navigate through the narrow passage by alternately turning left and turning right to move forward. Specifically, in FIG. 2, the robot walks from the position R1 to the position R2 (executed before starting to identify an opening of a new narrow passage), encounters an obstacle on its right side and uses point cloud data to fit a positioning contour line segment A2B2 (triggering the robot to start to identify the opening of the new narrow passage), and then identifies a first narrow passage opening between the position B2 and the position A0. Subsequently, the robot rotates its body to adjust the current walking direction to align with a direction indicated by the arrow marked by the index number \textcircled{2} in FIG. 2. Then, the robot selects a direction of A2 to B2 and walks in a straight line to the position R3 to pass through the first narrow passage opening (equivalent to entering the first narrow passage opening) in a corresponding section of the narrow passage. Similarly, the robot then collides with an obstacle in front of it at the position R3, uses point cloud data of this obstacle to fit the positioning contour line segment A3B3, then identify a second narrow passage opening between the position B2 and the position A3, and then rotates its body to adjust the current walking direction to align with a direction indicated by the arrow marked by the index number \textcircled{3} in FIG. 2. Subsequently, the robot walks straight to the position R4 along the direction indicated by the arrow marked by index number \textcircled{3} to pass through the second narrow passage opening. Next, the robot collides with an obstacle on right front side of it at the position R4, uses point cloud data of the obstacle to fit the positioning contour line segment A4B4, then identify a third narrow passage opening between the position B2 and the position A4, and then rotates its body to adjust the current walking direction to align with a direction indicated by the arrow marked by the index number \textcircled{4} in FIG. 2. Subsequently, the robot walks straight to the position R5 along the direction indicated by the arrow marked by index number \textcircled{4} to pass through the third narrow passage opening. Next, the robot collides with an obstacle on right front side of it at the position R5, uses point cloud data of the obstacle to fit the positioning contour line segment B5A5, then identify a fourth narrow passage opening between the position B5 and the position B4, and then rotates its body to adjust the current walking direction to align with a direction from the position B5 to the position A5. Subsequently, the robot walks straight to the position R6 along the direction from the position B5 to the position A5 to pass through the fourth narrow passage opening. As shown in FIG. 2, before the robot walks to the preset target position target, if the robot identifies the narrow passage opening between the position B5 and the position B4, the narrow passage opening will be determined as an exit of the narrow passage, which is specifically the narrow passage opening closest to the preset target position “target”. Then, the robot adjusts its current walking direction to align with the preset travel direction of the currently fitted positioning contour line segment, or deflects its current walking direction by the preset angle towards the passable area relative to the currently fitted positioning contour line segment. Subsequently, the robot walks in a straight line along the current walking direction, so as to bypass the target endpoint B4 of the positioning contour line segment of the most recently collided obstacle, before it begins to identify the exit of the narrow passage. After walking for the preset safe distance in a straight line without obstacles, the robot reaches the position R6 to leave the exit of the narrow passage. Preferably, the preset target position target is set outside the narrow passage. Then, the robot uses the heuristic search algorithm at the position R6 to plan a path towards the preset target position target, and then starts from the position R6 to walk straight along the planned path or navigation direction to the preset target position target. Therefore, once the robot collides with a new obstacle, a positioning contour line segment will be fitted for the new obstacle, the target endpoint of the positioning contour line segment of the new obstacle is obtained, and an opening of a channel where the target endpoint is located is identified as a narrow passage opening.

Based on the above embodiments, in the present disclosure, the robot adjusts the walking direction of the robot based on the collision between the robot and the obstacle and the fitting of the contour of the obstacle at various stages: before the robot identifies the opening of the narrow passage, when the robot starts to identify the opening of the narrow passage, after the robot identifies the opening of the narrow passage, before the robot enters the narrow passage, and after the robot enters the narrow passage. The robot then walks straight in the narrow passage to approach the preset target position. Additionally, the robot identifies the opening of the narrow passage based on sequential collisions with two obstacles and the fitting of the contour of each obstacle. This process distinguishes three identification states: before the robot identifies the opening of the narrow passage, when the robot starts to identify the opening of the narrow passage, and after the robot identifies the opening of the narrow passage. This approach facilitates the robot's advancement into a narrow passage and subsequently into the narrow passage again.

In the aforementioned embodiment, the method for the robot to identify an opening of a narrow passage includes: when the robot is triggered to identify the opening of the narrow passage, the robot first fits the positioning contour line segment of the most recently collided obstacle, and then extracts two obstacle avoidance points in a search direction of the positioning contour line segment; if a distance between the two obstacle avoidance points is detected to be within a preset distance range, a channel where the two obstacle avoidance points are located is identified as a narrow passage, and a gap formed between the two obstacles where the two obstacle avoidance points are respectively located is identified as the opening of the narrow passage, preferably an opening between the two obstacle avoidance points. Further, after the robot identifies the opening of the narrow passage, if it is detected that the robot's walking direction changes from a reference obstacle avoidance direction to the preset travel direction of the currently fitted positioning contour line segment or is deflected by the preset angle towards the passable area relative to the currently fitted positioning contour line segment, and the robot walks straight according to the changed walking direction, the robot will identify that it has entered the narrow passage. The changed walking direction is configured to point from a current position of the robot to the passable area inside the channel where the two obstacle avoidance points are located, preferably being parallel to the currently fitted positioning contour line segment. The reference obstacle avoidance direction is the preset travel direction of a previously fitted positioning contour line segment or is a direction deflected by the preset angle towards the passable area relative to the previously fitted positioning contour line segment. The previously fitted positioning contour line segment is a positioning contour line segment fitted for the most recently collided obstacle before the robot starts to identify the opening of the narrow passage. Specifically, before starting to identify the opening of the narrow passage, the robot collides with an obstacle and fits a corresponding positioning contour line segment. When the robot collides with another obstacle, it starts to identify the opening of the narrow passage. The positioning contour line segment fitted by the robot for the previously collided obstacle is the previously fitted positioning contour line segment, while the positioning contour line segment fitted by the robot for the subsequent collided obstacle is the currently fitted positioning contour line segment. The preset travel direction of the previously fitted positioning contour line segment is made different from the preset travel direction of the currently fitted positioning contour line segment. This allows the robot to use the directions and endpoints of the contour line segments of the two obstacles it collides with in sequence to identify and enter the opening of the narrow passage.

As an embodiment, when the robot extracts two obstacle avoidance points in the search direction of the positioning contour line segment, if it is detected that the robot's walking direction changes from the reference obstacle avoidance direction to the preset travel direction of the currently fitted positioning contour line segment or is deflected by the preset angle towards the passable area relative to the currently fitted positioning contour line segment, the distance between the two obstacle avoidance points is within the preset distance range, and the robot walks along a straight line along the changed walking direction, the robot will identify its behavior as entering the narrow passage, or having a tendency to enter the narrow passage by identifying the opening of the narrow passage. At this time, the robot is just about to enter the entrance of the narrow passage from the outside of the narrow passage, or the robot is located in front of the entrance of the channel where the two obstacle avoidance points are located and its walking direction is to the passable area inside the channel where the two detour points are located, and the robot may turn left and right. After the robot obtains the positioning contour line segment in the operation S1, the robot extracts two obstacle avoidance points in the search direction of the positioning contour line segment, which may involve selecting one obstacle avoidance point and then selecting another obstacle avoidance point along the search direction. These obstacle avoidance points are the endpoints of the fitted contour line segments and are the two closest endpoints respectively on two positioning contour line segments, forming the obstacle avoidance points on the left and right sides of the robot. Specifically, the robot determines that it has started to enter an opening of a narrow passage, which is a gap formed between the obstacles where the two obstacle avoidance points are respectively located. The gap is located in the passable area. The boundary lines of the channel where the gap is located can be actual contours of the obstacles or the fitted positioning contour line segments. A distance between the boundary lines is within the preset distance range to improve judgment accuracy. Preferably, a width of the gap is a distance between grids where the two endpoints of the gap are located on the robot's traveling plane. The two endpoints of the gap are respectively located on the contour lines of the corresponding obstacles or the fitted positioning contour line segments. No matter how frequently the robot collides with the obstacles it intends to bypass before entering the channel where the two obstacle avoidance points are located, the robot will identify the channel where the two obstacle avoidance points are located as a narrow passage, as long as the robot's walking direction changes from the reference obstacle avoidance direction to the preset travel direction of the currently fitted positioning contour line segment or is deflected by the preset angle towards the passable area relative to the currently fitted positioning contour line segment, and the distance between the two obstacle avoidance points is within the preset distance range making a process for the robot to navigate from the current position to the preset target position smoother, reducing a navigation passage, and improving the robot's navigation efficiency.

Preferably, the preset distance range is greater than or equal to a body width of the robot. Preferably, the preset distance range is greater than the body width of the robot. When a shape of the robot is circular, the body width of the robot is a diameter of its body. When a width of the opening of the channel where the two obstacle avoidance points are located (i.e., the gap formed between the two obstacle bypass points) is greater than or equal to the width of the robot's body, it is determined that the channel where the two obstacle avoidance points are located allows the robot to enter. Then, the robot can walk to or near one of the obstacle avoidance points to collide with a new obstacle, and at this time, the walking direction of the robot is adjusted to be parallel to a corresponding positioning contour line segment or to form a preset angle relative to the positioning contour line segment. The adjusted direction can either be a straight line pointing towards the preset target position or a zigzag path that extends through the channel where the two obstacle avoidance points are located and ultimately leads to the preset target position.

As an embodiment, if the robot does not collide with any obstacle while walking the preset safe distance in a straight line in the current walking direction, the robot will start to use the heuristic search algorithm to plan a navigation path after walking the preset safe distance in the narrow passage without colliding with any obstacle. The preset target position is an end point of the navigation path. A specific search starting point can be a position where the robot first collides with an obstacle, a position selected near the obstacle, or an obstacle avoidance point or a nearby area. Between the aforementioned operations S1 and S2, the method further includes: after the robot detects an obstacle (the robot may collide with it), and before the robot obtains two obstacle avoidance points by searching in a search direction of a positioning contour line segment of another obstacle (a newly detected obstacle, which can be close to the previously detected obstacle, and the two obstacles are considered to be adjacent to each other), the robot keeps walking along a same direction corresponding to a direction marked by the respective index numbers in FIG. 2. To a certain extent, the robot is guaranteed to pass through a narrow passage area. Terrain traversability information is stored as a cost value of each grid in a cost map. An accessibility cost is considered in the passage search stage, that is, an accessibility cost value is added into a cost function of the search algorithm, and the algorithm will tend to find a passage to an area with a low accessibility cost.

In the aforementioned embodiments, the robot generally uses a position where it collides with an obstacle for the first time as the search starting point. After that, as the robot walks along an obstacle avoidance path that is planed from the search starting point, upon a subsequent collision with another obstacle which indicates that the robot has detected this new obstacle, the positioning contour line segment is derived from the point cloud data collected by the ranging sensor. The positioning contour line segment is a fitting result of the point cloud data reflected from another obstacle (derived from part of a line segment of the envelop curve of another obstacle and overlapping with a current position of the robot). This approach allows the detection of the gap or channel between the two detected obstacles. In some embodiments, the positioning contour line segment may be a fitted line segment calculated based on the point cloud data pre-collected by the robot (for example, coming from the contour of the obstacle that the robot first collided with) or may be parallel to this fitted line segment. The robot may not collide with the other obstacle, but the robot can predict the gap that may be formed between two different obstacles. Therefore, the robot regards the positioning contour line segment as a boundary line where one end of the gap or one side of the channel is located. Preferably, the narrow passage is a passage composed by using the contour lines of the two obstacles (the fitting result) as the boundary lines. A minimum distance between the obstacle avoidance points extracted from the contour lines of the two obstacles is greater than or equal to a minimum value of the preset distance range. A minimum value of the preset distance range is greater than the width of the robot's body. The width of the narrow passage is in the preset distance range, and the entrance of the narrow path is also in the preset distance range. The narrow passage opening can be a small doorway in a room, where the obstacles on both sides of the doorway are four walls in the same room. The four walls are continuous and integrated. In addition, the walls on the left and right sides of the passage where the obstacle avoidance points are located can be approximately parallel.

It should be noted that the robot will use a heuristic search algorithm to plan a navigation path, and the preset target position is the end point of the navigation passage. After the navigation path has been planned, the robot will walk along the navigation path. When the robot has detected an obstacle using the ranging sensor, for example, when it has detected the obstacle for the first time or even when it collides with the obstacle, the robot starts using the heuristic search algorithm from its current position to plan a navigation path bypassing the currently detected obstacle, and mark the navigation path as the obstacle avoidance path, wherein the preset target position is the end point of the obstacle avoidance path. Specifically, when the robot starts to use its current position or preset starting position as the search starting point, the robot searches, in the direction of the search starting point pointing to the preset target position (i.e., a direction from the search starting point start to the present target position target in FIG. 2), a free grid (a grid area representing a passable area in the grid map) in the neighborhood of the search starting point to serve as a path node during the process of the robot using the heuristic search algorithm to plan a path. This avoids the path node from being located in an area occupied by obstacles. The robot searches multiple path nodes in the neighborhood of the search starting point, these path nodes are free grids, and each path node corresponds to an initial search direction. Then, each path node is updated to become a new search starting point, and the robot then searches for free grids in the neighborhood of this new starting point in the direction of the new search starting point to the same preset target position. This process is repeated until the preset target position has been searched in the grid map. According to an order in which the searched free grids have been searched, these free grids are connected to form multiple navigation paths or obstacle avoidance paths. The robot may search one navigation path or one obstacle avoidance path corresponding to each search starting direction.

Preferably, when the robot detects the first obstacle using a line laser sensor, the robot has collided with the first obstacle; when the robot walks to the gap formed between the first obstacle and the second obstacle, the robot has collided with the second obstacle; and the robot sets the preset distance range to be greater than or equal to the width of the robot's body, so that in a case where the distance between the two obstacle avoidance points is greater than or equal to the width of the robot's body, it is determined that the gap formed between the obstacles where the obstacle avoidance points are located is an opening of a narrow passage allowing the robot to enter. An upper limit of the preset distance range is a sum of the width of the robot's body and a preset redundancy. Since the width of the narrow passage is only slightly larger than the width of the robot's body, a preset distance range is set for the judgment to reduce an error interference of a calculated contour line in the process of identifying the narrow passage. Specifically, the minimum value of the preset distance range (lower limit value) is larger than the width of the robot's body, while the maximum value (upper limit value) of the preset distance range is only slightly larger than the width of the robot's body and does not exceed twice the width of the robot's body. The preset distance range can be determined based on the width of the robot's body and a preset fitting error. The setting of the preset redundancy may allow defining the channel whose width is close to the width of the robot's body as a narrow passage. For example, if the width of a cleaning robot is 30 cm, the preset distance range may be 32 cm to 35 cm. That is, when a center of the robot is located at a center in a width direction of the entrance of the channel where the two obstacle avoidance points are located, the preset redundancy is set in a manner that a gap size between the channel and each of the left and right sides of the robot is between 1 cm and 2 cm. Correspondingly, the center position of the robot can be represented by position R1, position R2, position R3, and position R4, position R5, and position R6 in sequence. To sum up, the foregoing embodiment uses a change in the walking direction before the robot enters the gap formed between the two obstacles and the distance between the obstacle avoidance points corresponding to the two obstacles to identify whether the robot has started to enter a narrow passage, which avoids an error caused by contour fitting calculation of the obstacles to the narrow passage identification, improves the accuracy of the narrow passage identification, and improves a success rate of the robot entering the narrow passage.

As an embodiment, the robot sets a search direction of a positioning contour line segment as a direction perpendicular to the positioning contour line segment, to form a width direction of the channel where the two obstacle avoidance points are located. The two obstacle avoidance points are distributed along the search direction of the positioning contour line segment, and one is distributed in an obstacle that the robot most recently collides with before it starts to identify the opening of the narrow passage, and the other one is in another obstacle that the robot collides with when it starts to identify the opening of the narrow passage. In this embodiment, the positioning contour line segment corresponds to the obstacle where one of the obstacle avoidance points is located. Taking the uppermost obstacle in FIG. 2 as an example, the line segment AB is its positioning contour line segment, which belongs to a fitted line segment of a corner point at the bottom left of the uppermost obstacle in FIG. 2, but not necessarily belonging to an actual contour of the obstacle. The line segment A1B1 may form one boundary line of the channel where the two obstacle avoidance points are located, that is, the boundary line of the narrow passage identified in the above embodiments. The perpendicular line formed in the search direction of the line segment A1B1 can be a line passing through one corner point of the uppermost obstacle (black rectangle) shown in FIG. 2 to match the outline and distribution position of the obstacle. Two obstacle avoidance points are located respectively on the positioning contour line segments of the obstacles closest to the left and right sides of the robot. These two points can be understood as the endpoints with the smallest distance between them among the endpoints of the positioning contour line segments of the two obstacles, and there is a gap existing between the two endpoints. In some embodiments, the distance between the two obstacle avoidance points is the minimum distance between the endpoints of the two positioning contour line segments where the obstacle avoidance points are located. This distance is used to determine the passability of the gap between the two avoidance points.

Preferably, the preset distance range is set to be greater than or equal to the width of the robot's body. The preset safety distance is set to be equal to the width of the robot's body. The preset angle is set to guide the robot to leave an obstacle that the robot currently collided, or bypass any endpoint of the positioning contour line segment of the currently collided obstacle, so as to walk to the passable area connected to the present target position. The shortest passable path is a shortest one among paths leading to the preset target position which are planned by the robot through respectively taking the two endpoints of the positioning contour line segment as the search starting point and using the heuristic search algorithm.

Preferably, when the robot walks inside the narrow passage, the shortest distance between each of the boundary lines on both sides of the entrance of the narrow passage and a corresponding side of the robot is equal to half of the preset redundancy. For example, when the robot moves along a center line of a narrow passage and enters the narrow passage opening, a perpendicular distance between the robot's left side and the obstacle avoidance point at its left side is equal to half of the preset redundancy, and a perpendicular distance between the robot's right side and the obstacle avoidance point at its right side is equal to half of the preset redundancy. In this embodiment, half of the preset redundancy is preferably 1 cm to 2 cm, so as to avoid calculation errors in fitting of the contour line.

In some embodiments, a working area of the robot may include an area defined by the boundary line, and a non-working area may be formed between obstacles, or formed between the working areas defined by the boundary lines. The non-working area may be formed between corresponding boundary lines of two working areas, or a gap channel between two wall obstacles. The non-working area herein generally refers to a channel with a narrow width, referred to as a narrow passage. The entrance and exit of the narrow passage are both set as the openings of narrow passage, where the two sides of the narrow passage are the contour lines of two obstacles. When setting a moving path, the cleaning robot is generally modelled as a circle. In order to facilitate the cleaning robot to move to the preset target position, the set moving path may pass through this narrow passage. Generally, a gap area between two or more obstacles (such as a passage between two walls) appears on the grid map as a free passage. The free passage refers to a passage connecting two different working areas, which may be a passable path of the robot in a case where a width of the free passage is greater than the width of the robot's body. By detecting the entrance, exit, length, and width of the channel, an opening of a narrow passage and the narrow passage allowing the robot to pass through may be identified, and further information of positions covered by the narrow passage may be determined. For example, a grid area of a doorway under a wall, a channel between two walls, and a channel surrounded by three walls and having only one gap to be identified may be identified. The channel in an actual working scene of the robot has certain characteristics, including a three-dimensional shape and a size.

It should be additionally noted that, regarding the aforementioned openings of narrow passages, narrow passages, or gaps, there exists, in an area where the robot operates, a doorway connecting adjacent room areas on horizontal ground, a gap between two parallel walls, and a gap formed between two low obstacles. An entrance to the doorway or an entrance to the gap can be configured as an opening formed between two obstacles (which is at least an opening between contours of the two obstacles). These obstacles may exist as independent entities. When the robot scans the environment using a line laser sensor, the sensor can accurately identify and capture positions of the two endpoints of the opening as well as width information of the opening. These scanned data are then converted into point cloud coordinates in a corresponding coordinate system, ultimately mapping the two endpoints of the opening to corresponding grids on the grid map. In some embodiments, when the robot senses its surrounding environment through collision, once the robot contacts the two endpoints of the opening, a collision sensor of the robot marks contour points of the obstacles or the positioning contour line segments it collides with onto the corresponding grids of the grid map. Additionally, in some embodiments, an evaluation metric is introduced to represent the robot's traversability at the gap formed between the obstacles or at the corresponding grid (such as the number of free grids between the two endpoints or its proportion within a width range of the opening). This metric can indicate probability of the robot passing through the corresponding grid area. Generally, the credibility of a gap scanned by the robot using a ranging sensor is higher than a gap detected by the robot through collision, as the positioning accuracy of the ranging sensor is superior to that achieved through physical contact by the robot.

In the aforementioned embodiments, the robot collects point cloud data through a ranging sensor. The point cloud data, which represents the positional information of an obstacle detected by the ranging sensor through reflection, is a collection of discrete points and may carry environmental noise (reflecting interference from ambient light or surface material of the obstacles). The robot then processes the collected point cloud data by fitting it into the contour line of the obstacle, representing local contours or envelopes of the detected obstacle. Specifically, this fitting process involves sequential steps including sorting, grouping (to distinguish different types of obstacles), filtering, segmented interpolation fitting, and finally connecting the coordinate points of each fitted curve within each group to obtain the envelope or contour line of the obstacle. The envelopes or contour lines of the obstacles may include fitted line segments, fitted curves, or a combination thereof. Preferably, the robot controls the virtual expansion of the contour lines generated from the fitting process, with the expansion radius set to a radius of an inscribed circle or a radius of a circumcircle of a contour projection of the robot. This forms a fitted circle surrounding the obstacle, thereby forming the envelope of the obstacle. Thus, the aforementioned positioning contour line segments belong to the envelope of the obstacle.

Based on the foregoing embodiments, the present disclosure further discloses a chip that stores program code. When the program code is executed, the operations disclosed in the foregoing embodiments are implemented. When the program code corresponding to the operations of the navigation method for a robot to pass through a narrow passage is stored in the chip, it is regarded as a computer program product. This computer program is operable to cause a computer to execute some or all of the operations of any method described in the embodiments relating to the navigation method for the robot to pass through the narrow passage. The robot equipped with the aforementioned chip inside utilizes point cloud data to obtain positioning contour line segments and searches for relevant obstacle avoidance points before and after identifying narrow passages openings and before entering the narrow passages. The robot identifies narrow passages slightly wider than the width of the robot's body and determines that the robot can precisely enter these passages, sequentially navigate through multiple openings of narrow passages, and continuously pass through multiple narrow passages. This capability also facilitates real-time planning of a navigation path that is more adaptable to the environment and ensures smoother passage.

The present disclosure further discloses a robot equipped with a distance sensor. The robot is provided with the aforementioned chip, which is used to control the robot to utilize the distance sensor to detect point cloud data of obstacles. From the point cloud data, the chip fits corresponding positioning contour line segments, facilitating the robot's navigation through narrow passages by executing the aforementioned navigation method. Based on the above embodiments, in the present disclosure, the robot adjusts the walking direction of the robot based on the collision between the robot and the obstacle and the fitting of the obstacle of the contour of the obstacle at various stages: before the robot identifies the opening of the narrow passage, when the robot starts to identify the opening of the narrow passage, after the robot identifies the opening of the narrow passage, before the robot enters the narrow passage, and after the robot enters the narrow passage. The robot then walks straight in the narrow passage to approach the preset target position. Additionally, the robot identifies the opening of the narrow passage based on sequential collisions with two obstacles and the fitting of the contour of each obstacle. This process distinguishes three identification states: before the robot identifies the opening of the narrow passage, when the robot starts to identify the opening of the narrow passage, and after the robot identifies the opening of the narrow passage. This approach facilitates the robot's transition into a narrow passage and subsequently into the narrow passage again.

It should be noted that, for the sake of simplicity, the aforementioned method embodiments are described as a series of action combinations. However, those skilled in the art should understand that the present disclosure is not limited by the described sequence of actions, as certain operations may be performed in other orders or simultaneously according to the present disclosure. Furthermore, those skilled in the art should further understand that the embodiments described in the specification are preferred embodiments, and the actions and modules involved are not necessarily essential to the present disclosure.

In the aforementioned embodiments, the descriptions of each embodiment have its own emphases. For parts not detailed in a particular embodiment, reference may be made to the relevant descriptions in other embodiments.

In several embodiments provided by the present disclosure, it should be understood that the disclosed apparatus may be implemented in other ways. For example, the described apparatus embodiments are merely illustrative. For instance, the division of units is only a logical functional division, and in actual implementation, there may be other ways of division. For example, multiple units or components may be combined or integrated into another system, or some features may be omitted or not executed. Additionally, the displayed or discussed mutual couplings or direct couplings or communication connections may be indirect couplings or communication connections through some interfaces, apparatuses, or units, and may be electrical or of other forms.

The units described as separate components may or may not be physically separated. The components displayed as units may or may not be physical units, that is, they may be located in one place or distributed across multiple network units. Some or all of the units may be selected according to actual needs to achieve the objectives of the embodiments.

Moreover, the functional units in the various embodiments of the present disclosure may be integrated into a single processing unit, or each unit may exist physically alone, or two or more units may be integrated into one unit. The integrated unit may be implemented in hardware or in the form of software functional units.

If the integrated unit is implemented as software functional units and sold or used as standalone products, it may be stored in a computer-readable storage medium. Based on this understanding, the technical solutions of the present disclosure, in essence, or the part contributing to the prior art, or all or part of the technical solutions, may be embodied in the form of a software product. This computer software product is stored in a storage medium and includes instructions for causing a computer device (which may be a personal computer, server, or network device, etc.) to perform all or part of the operations of the methods described in the various embodiments of the present disclosure. The aforementioned storage medium includes: USB flash drives, read-only memory (ROM), random access memory (RAM), portable hard drives, magnetic disks, or optical disks, and other media that can store program code.

Those of ordinary skill in the art can understand that all or part of the operations in the various methods of the above embodiments may be completed by a program instructing relevant hardware. The program may be stored in a computer-readable storage medium, which may include: flash drives, read-only memory (ROM), random access memory (RAM), magnetic disks, or optical disks, etc.

The above provides a detailed introduction to an embodiment of the present disclosure. Specific examples are used herein to explain the principles and implementation of the present disclosure. The descriptions of the above embodiments are only intended to help understand the methods and core ideas of the present disclosure. In addition, for those of ordinary skill in the art, based on the ideas of the present disclosure, there may be changes in specific implementations and application scopes. In summary, the content of this specification should not be construed as limiting the present disclosure.

1. A navigation method for a robot to pass through a narrow passage, comprising:
operation S1 of the robot fitting a positioning contour line segment, as a currently fitted positioning contour line segment, for an obstacle when the robot collides with the obstacle after entering the narrow passage, the robot then rotating until a current walking direction of the robot is consistent with a preset travel direction of the currently fitted positioning contour line segment or the currently waling direction of the robot is deflected by a preset angle towards a passable area of the narrow passage relative to the currently fitted positioning contour line segment, so that the robot is not currently blocked by the obstacle from moving forward; and
operation S2 of the robot walking straight in the current walking direction until it collides with the obstacle and then the robot proceeding to execute the operation SI;
wherein the operation S2 is executed by the robot after the operation SI; and the robot stops executing the operation S1 when the robot reaches a preset target position, and determines that the robot has passed through the narrow passage.

2. The navigation method according to claim 1, wherein in the operation S1, for each positioning contour line segment fitted by the robot, the robot sets an endpoint of the positioning contour line segment that forms a shortest passable path relative to the preset target position as a target endpoint of the positioning contour line segment,
wherein the shortest passable path is located within the passable area of the narrow passage entered by the robot, the robot configures a direction of an end point of the positioning contour line segment other than the target endpoint pointing to the target endpoint as the preset travel direction of the positioning contour line segment.

3. The navigation method according to claim 2, wherein the robot configures a channel where the target endpoint of each positioning contour line segment is located as the narrow passage, the robot sets the positioning contour line segment as a boundary line of the narrow passage, each time the robot collides with a new obstacle, the robot fits a positioning contour line segment for the new obstacle, obtains the target endpoint of the positioning contour line segment of the new obstacle, and identifies an opening of the channel where the target endpoint is located as an opening of the narrow passage.

4. The navigation method according to claim 2, wherein in the operation S2, before the robot reaches the preset target position, if the robot identifies an opening of the narrow passage, the robot determines the opening of the narrow passage as an exit of the narrow passage, and then adjusts the current walking direction to align with the preset travel direction of the currently fitted positioning contour line segment or deflect the current walking direction by the preset angle towards the passable area relative to the currently fitted positioning contour line segment;
and then the robot walks straight in the current walking direction to exit the narrow passage.

5. The navigation method according to claim 2, wherein the navigation method further comprises that: before the robot enters the narrow passage, if the robot identifies an opening of the narrow passage, the robot identifies the opening of the narrow passage as an entrance of the narrow passage, and then adjusts the current walking direction to align with the preset travel direction of the currently fitted positioning contour line segment or deflect the current walking direction by the preset angle to the passable area relative to the currently fitted positioning contour line segment;
and then the robot walks straight in the current walking direction to enter the entrance of the narrow passage, and proceeds to execute the operation S1.

6. The navigation method according to claim 5, wherein before the robot starts to identify the opening of the narrow passage, if the robot collides with the obstacle, the robot marks the obstacle as a most recently detected obstacle before starting to identify the opening of the narrow passage, fits the positioning contour line segment for the obstacle, then adjusts the current walking direction to align with the preset travel direction of the currently fitted positioning contour line segment, so that the robot walks along the currently fitted positioning contour line segment, until colliding with a new obstacle, and then the robots fits a corresponding positioning contour line segment for the new obstacle, and then starts to identify the opening of the narrow passage.

7. The navigation method according to claim 2, wherein each time the robot rotates until the current walking direction aligns with the preset travel direction of the currently fitted positioning contour line segment or is deflected by the preset angle towards the passable area relative to the currently fitted positioning contour line segment, the robot walks straight in the current walking direction for a preset safety distance, and during the straight walking, detects whether the robot collides with the obstacle;
if the robot collides with the obstacle, the robot proceeds to execute the operation S1;
otherwise, it is determined that the robot has passed through the narrow passage, then uses a heuristic search algorithm to plan a path towards the preset target position or to a position closest to another detected obstacle in the current walking direction, and walks along the planned path until the robot identifies and enters an entrance of another narrow passage, and then proceeds to execute the operation S1.

8. The navigation method according to claim 4, wherein the robot identifying of the opening of the narrow passage comprises that:
the robot first fits a positioning contour line segment for a most recently collided obstacle, then extracts two obstacle avoidance points in a search direction of the positioning contour line segment;
if a distance between the two obstacle avoidance points is within a preset distance range, the robot identifies a channel where the two obstacle avoidance points are located as the narrow passage and identifies a gap formed between obstacles where the two obstacle avoidance points are respectively located as the opening of the narrow passage.

9. The navigation method according to claim 8, wherein after the robot identifies the opening of the narrow passage, if the robot detects that a walking direction of the robot changes from a reference obstacle avoidance direction to the preset travel direction of the currently fitted positioning contour line segment or is deflected by the preset angle towards the passable area relative to the currently fitted positioning contour line segment, and that the robot walks straight in the changed walking direction, the robot identifies that it has entered the narrow passage;
wherein the changed walking direction is configured to point from a current position of the robot to a passable area inside the channel where the two obstacle avoidance points are located,
the reference obstacle avoidance direction is a preset travel direction of a previously fitted positioning contour line segment or is deflected by the preset angle towards a passable area relative to a previously fitted positioning contour line segment, and
the previously fitted positioning contour line segment is a positioning contour line segment fitted for the most recently collided obstacle before the robot starts to identify the opening of the narrow passage.

10. The navigation method according to claim 9, wherein before starting to identify the narrow passage entrance, the robot collides with one obstacle and fits a corresponding positioning contour line segment for the obstacle; when the robot subsequently collides with another obstacle, it starts to identify the opening of the narrow passage;
the positioning contour line segment fitted by the robot for the previously collided obstacle is the previously fitted positioning contour line segment, while a positioning contour line segment fitted by the robot for the subsequent collided obstacle is the currently fitted positioning contour line, wherein the preset travel direction of the previously fitted positioning contour line segment is made different from the preset travel direction of the currently fitted positioning contour line segment.

11. The navigation method according to claim 10, wherein the robot sets the search direction of the positioning contour line segment as a direction perpendicular to the positioning contour line segment, to form a width direction of the channel where the two obstacle avoidance points are located, and
the two obstacle avoidance points are distributed along the search directions of the positioning contour line segment, and respectively in the obstacle that the robot most recently collides with before the robot starts to identify the opening of the narrow passage, and in the another obstacle that the robot collides with when the robot starts to identify the opening of the narrow passage.

12. The navigation method according to claim 8, wherein the preset distance range is set to be greater than or equal to a width of the robot's body;
the preset angle is set to guide the robot to leave a currently collided obstacle, or bypass any endpoint of the positioning contour line segment of the currently collided obstacle, so as to walk to the passable area connected to the present target position.

13. A chip storing program code, wherein when the program code is executed, a navigation method for a robot to pass through a narrow passage is implemented, the method comprising:
operation S1 of the robot fitting a positioning contour line segment, as a currently fitted positioning contour line segment, for an obstacle when the robot collides with the obstacle after entering the narrow passage,, the robot then rotating until a current walking direction of the robot is consistent with a preset travel direction of the currently fitted positioning contour line segment or the currently waling direction of the robot is deflected by a preset angle towards a passable area of the narrow passage relative to the currently fitted positioning contour line segment, so that the robot is not currently blocked by the obstacle from moving forward; and
operation S2 of the robot walking straight in the current walking direction until it collides with the obstacle and then the robot proceeding to execute the operation S1;
wherein the operation S2 is executed by the robot after the operation SI; and the robot stops executing the operation S1 when the robot reaches a preset target position, and determines that the robot has passed through the narrow passage.

14. A robot equipped with a distance sensor, wherein the robot is provided with a chip, which is configured to control the robot to use the distance sensor to detect point cloud data of a obstacle and correspondingly fit a positioning contour line segment from the point cloud data, so as to execute a navigation method for a robot to pass through a narrow passage, comprising:
operation S1 of the robot fitting a positioning contour line segment, as a currently fitted positioning contour line segment, for an obstacle when the robot collides with the obstacle after entering the narrow passage,, the robot then rotating until a current walking direction of the robot is consistent with a preset travel direction of the currently fitted positioning contour line segment or the currently waling direction of the robot is deflected by a preset angle towards a passable area of the narrow passage relative to the currently fitted positioning contour line segment, so that the robot is not currently blocked by the obstacle from moving forward; and
operation S2 of the robot walking straight in the current walking direction until it collides with the obstacle and then the robot proceeding to execute the operation S1;
wherein the operation S2 is executed by the robot after the operation S1; and the robot stops executing the operation S1 when the robot reaches a preset target position, and determines that the robot has passed through the narrow passage.

15. The navigation method according to claim 7, wherein the preset safety distance is set to be equal to the width of the robot's body; and
the shortest passable path is a shortest one among paths leading to the preset target position which are planned by the robot through respectively taking the two endpoints of the positioning contour line segment as a search starting point and using the heuristic search algorithm.

16. The chip according to claim 13, wherein in the operation S1, for each positioning contour line segment fitted by the robot, the robot sets an endpoint of the positioning contour line segment that forms a shortest passable path relative to the preset target position as a target endpoint of the positioning contour line segment,
wherein the shortest passable path is located within the passable area of the narrow passage entered by the robot, the robot configures a direction of an end point of the positioning contour line segment other than the target endpoint pointing to the target endpoint as the preset travel direction of the positioning contour line segment.

17. The chip according to claim 16, wherein the robot configures a channel where the target endpoint of each positioning contour line segment is located as the narrow passage, the robot sets the positioning contour line segment as a boundary line of the narrow passage,
each time the robot collides with a new obstacle, the robot fits a positioning contour line segment for the new obstacle, obtains the target endpoint of the positioning contour line segment of the new obstacle, and identifies an opening of the channel where the target endpoint is located as an opening of the narrow passage.

18. The chip according to claim 16, wherein in the operation S2, before the robot reaches the preset target position, if the robot identifies an opening of the narrow passage, the robot determines the opening of the narrow passage as an exit of the narrow passage, and then adjusts the current walking direction to align with the preset travel direction of the currently fitted positioning contour line segment or deflect the current walking direction by the preset angle towards the passable area relative to the currently fitted positioning contour line segment;
and then the robot walks straight in the current walking direction to exit the narrow passage.

19. The chip according to claim 16, wherein the navigation method further comprises that: before the robot enters the narrow passage, if the robot identifies an opening of the narrow passage, the robot identifies the opening of the narrow passage as an entrance of the narrow passage, and then adjusts the current walking direction to align with the preset travel direction of the currently fitted positioning contour line segment or deflect the current walking direction by the preset angle to the passable area relative to the currently fitted positioning contour line segment;
and then the robot walks straight in the current walking direction to enter the entrance of the narrow passage, and proceeds to execute the operation S1.

20. The chip according to claim 19, wherein before the robot starts to identify the opening of the narrow passage, if the robot collides with the obstacle, the robot marks the obstacle as a most recently detected obstacle before starting to identify the opening of the narrow passage, fits the positioning contour line segment for the obstacle, then adjusts the current walking direction to align with the preset travel direction of the currently fitted positioning contour line segment, so that the robot walks along the currently fitted positioning contour line segment, until colliding with a new obstacle, and then the robots fits a corresponding positioning contour line segment for the new obstacle, and then starts to identify the opening of the narrow passage.
